(19) United States
(12) Patent Application Publication
(10) Pub. No.: US 2010/0132963 A1
(43) Pub. Date: Jun. 3, 2010

(54) Method and Device for Fire Fighting

(75) Inventors: Dirk Sprakel, Koln (DE); Max Lakkonen, Rosrath (DE); Roger Dirksmeier, Menden (DE)

Correspondence Address: Sunstein Kann Murphy & Timbers LLP, 125 SUMMER STREET, BOSTON, MA, 02110-1618, US

(73) Assignee: FOGTEC BRANDSCHUTZ GMBH & CO. KG, Köln (DE)

(21) Appl. No.: 12/373,091

(22) PCT Filed: May 8, 2007
(86) PCT No.: PCT/EP07/54436

§ 371 Date: Feb. 13, 2009

(30) Foreign Application Priority Data
Jul. 12, 2006 (DE) 10 2006 032 503.6

(51) Int. Cl. A62C 35/02

(52) U.S. Cl. 169/46; 169/11

(57) ABSTRACT

The invention relates to a method and a fire fighting device, wherein at least one extinguishing fluid container 2 is pressurized with propellant for releasing an extinguishing fog via at least one extinguishing fog nozzle 4, and wherein at least one extinguishing gas nozzle 6 is pressurized with propellant, wherein the pressurization of the extinguishing fluid container 2 and the extinguishing gas nozzle 6 takes place via a joint propellant supply 8. To render possible targeted pressurization with either extinguishing fluid or extinguishing gas, the invention proposes that optionally only the extinguishing fluid container 2 or only the extinguishing gas nozzle 6 is pressurized with propellant via the joint propellant supply 8.

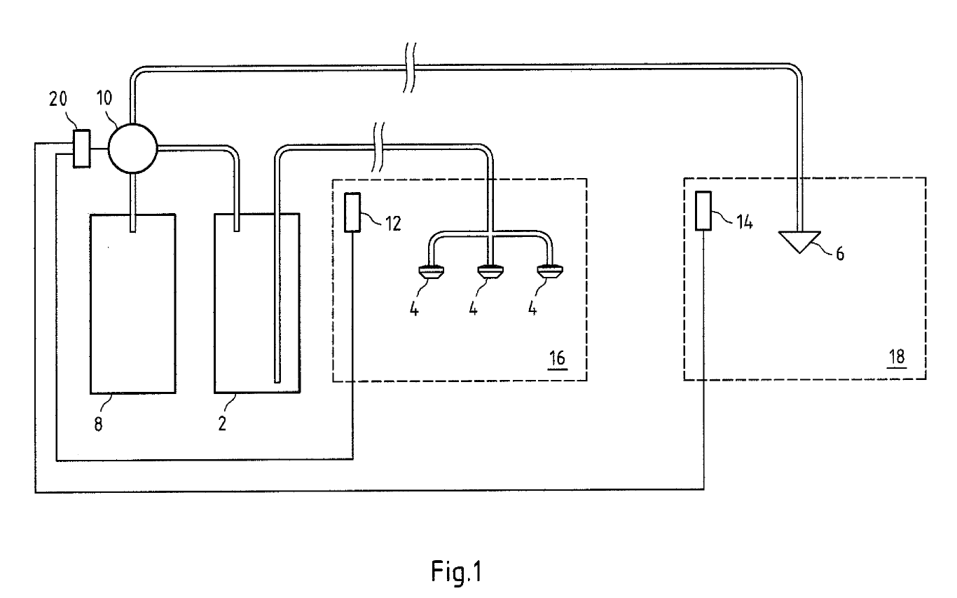

The invention generally relates to a fire fighting method and device.

Nowadays it is known to extinguish fires in areas using very fine fog. In this case extinguishing fluids under high pressure, for example water or water mixed with additives, are released from extinguishing fog nozzles. With pressures of 100 bar and more the extinguishing fog nozzles produce a finely distributed extinguishing fog, which has good extinguishing properties, since this cools the fire source well and thus successfully extinguishes the fire.

However, it has been shown that not all fire sources can be successfully extinguished by means of such extinguishing fog. For example fires in areas having difficult to access corners and small volumes can be extinguished with extinguishing gas better than with extinguishing fog. Thus it is known for example from German Patent DE 694 22 926 T3 to release liquid fog into a main sector of an entire area to be extinguished by means of spray heads and, as well as spraying liquid fog, to spray gas locally inside a sector in the area to be extinguished. The volume of the sector, in which gas is sprayed, is narrowly circumscribed within the total volume.

With the method known from this document however, it is a disadvantage that mixing of extinguishing fluid and extinguishing gas cannot be prevented. For example, through this known device it cannot be prevented that extinguishing fluid is introduced into sensitive areas, in which only extinguishing gas should be used. On the other hand it cannot be prevented that extinguishing gas is introduced into an area, which should only be extinguished with extinguishing fluid. The valve arrangement described is not suitable for optional pressurization either with extinguishing fog or extinguishing gas.

Therefore the object of the invention was to provide fire fighting, which on the one hand imposes low technical demands and on the other hand meets high safety requirements.

This object is achieved according to one aspect by a fire fighting method, wherein at least one extinguishing fluid container is pressurized with propellant for producing an extinguishing fog via at least one extinguishing fog nozzle, and wherein at least one extinguishing gas nozzle is pressurized with propellant, wherein the pressurization of the extinguishing fluid container and the extinguishing gas nozzle takes place via a joint propellant supply. The method is characterized in that optionally exclusively the extinguishing fluid container or exclusively the extinguishing gas nozzle is pressurized with propellant via the joint propellant supply.

It has been recognized that a joint propellant supply for extinguishing fluid containers and extinguishing gas nozzles only imposes low technical demands. Thus providing the propellant via a joint propellant supply, a compressed gas cylinder for example, is easy to put into effect. For example this can be simply put into effect inside railway trains or also other mobile systems. It is no longer necessary to keep a different propellant supplies for fire fighting with extinguishing gas and for fire fighting with extinguishing fog. Furthermore, it has been recognized that due to health and safety regulations in many cases extinguishing gas must be prevented from entering areas, which are extinguished with extinguishing fluid. On the other hand areas, which contain technical equipment for example, are sensitive to water, so that only extinguishing gas should be used here. Therefore the invention proposes that either the extinguishing fluid container or the extinguishing gas nozzle is pressurized with propellant via the joint propellant supply. This means that the joint propellant supply is used to release either extinguishing fog in an area intended for this by means of extinguishing fog nozzles, or extinguishing gas in an area intended for this by means of extinguishing gas nozzles. Mixing of extinguishing fluid and propellant is avoided. Preferably the propellant is an extinguishing gas.

In accordance with an advantageous exemplary embodiment it is proposed that the optional pressurization of the extinguishing fluid container or the extinguishing gas nozzle is controlled by means of a valve. The valve thus is preferably located between the propellant supply and the extinguishing fluid container and/or the extinguishing gas nozzles. For example the valve can be placed on a branch in a pipeline. A first branch leads to the extinguishing fluid container and a second branch leads to the extinguishing gas nozzle. The valve may be triggered by means of a control. The value can regulate the optional supply of propellant to the extinguishing fluid container or the extinguishing gas nozzle. The valve is therefore preferably a rotary valve. Regulation by means of actuators is possible. The actuators are activated by means of a suitable control and triggered preferably by fire alarms acting independently from one another, which are arranged at different rooms/areas.

Preferably, a fire alarm is respectively located in an area/room in which extinguishing fog nozzles are provided and in an area/room in which extinguishing gas nozzles are provided.

These rooms/areas are preferably separate from one another. For example these may be an engine room within a railway train and a passenger compartment. Inside the engine room the extinguishing fluid must be prevented from coming into contact with the technical equipment of the vehicle. Therefore the use of extinguishing gas is preferred here. In the passenger compartment, extinguishing gas should be prevented from mixing with extinguishing fog, since this is frequently dangerous to health.

In accordance with an advantageous exemplary embodiment the propellant is selected from the group of inert gas, nitrogen, carbon dioxide, argon, halon or combinations thereof

A further embodiment relates to a fire fighting device, comprising at least one extinguishing fluid container connected to at least one extinguishing fog nozzle producing extinguishing fog, at least one extinguishing gas nozzle releasing propellant and a propellant supply feeding the extinguishing fluid container and the extinguishing gas nozzle jointly with propellant. The fire fighting device is characterized in that the propellant supply is connected to the extinguishing fluid container and the extinguishing gas nozzle in such a way that optionally exclusively the extinguishing fluid container or exclusively the extinguishing gas nozzle is fed with propellant.

Further advantages will become clear from the dependent claims. The invention is described in detail below on the basis of a drawing showing an exemplary embodiment. In the drawing the single FIGURE shows a fire fighting device.

An extinguishing fluid container 2, extinguishing fog nozzles 4, an extinguishing gas nozzle 6, a propellant supply 8, a valve 10, fire alarms 12 and 14 and an actuator 20 are shown. The fire alarm 12 is located together with the extinguishing fog nozzles 4 in a passenger compartment 16. The fire alarm 14 is located together with the extinguishing gas nozzle 6 in an engine room 18. The arrangement shown works as follows:

The propellant supply 8 is provided by a compressed gas cylinder. An extinguishing gas is stored under high pressure in the compressed gas cylinder. The valve 10 in the inoperative position is adjusted in such a way that the propellant supply 8 is closed off from the rest of the pipeline.

In the event of a fire in the passenger compartment 16 the fire alarm 12 releases an impulse, which triggers the actuator 20. The actuator 20 moves the valve 10 in such a way that a connection is made between propellant supply 8 and extinguishing fluid container 2. Propellant flows out of the propellant supply 8 into the extinguishing fluid container 2 and propels extinguishing fluid stored therein via a pipeline into the extinguishing fog nozzles 4. As a result of the high pressure, with which the propellant enters the extinguishing fluid container 2, this is propelled from the extinguishing fluid container and is supplied at high pressure to the extinguishing fog nozzles 4. As a result, finely distributed fog is sprayed into the passenger compartment 16. The extinguishing fog extinguishes the fire and the fire alarm 12 reports this to the actuator 20 which thereupon moves the valve 10 to the closed position again.

A sensor circuit arranged in the extinguishing fluid container 2 detects whether any more extinguishing fluid is still present in the extinguishing fluid container 2. If no more extinguishing fluid is present this arrangement closes the connection between extinguishing fluid container 2 and propellant supply 8, so that no propellant can enter the pipeline and the extinguishing fog nozzles 4 and thus the passenger compartment 16.

In the event of a fire in the engine room/compartment 18, the fire alarm 14 releases an impulse, which triggers the actuator 20 to move the valve 10 in such a way that a connection is made between propellant supply 8 and extinguishing gas nozzle 6. Propellant can enter the extinguishing gas nozzle 6 from the propellant supply 8 and disperse in the engine compartment 18. As a result, the fire in the engine compartment 18 is extinguished. After the fire has been extinguished, the fire alarm 14 reports this to the actuator 20 which thereupon closes the valve 10 again.

The arrangement shown makes it possible to supply targeted areas separate from one another via a joint propellant supply either with extinguishing fluid or extinguishing gas. Mixing of extinguishing fluid and extinguishing gas is avoided so that high safety requirements are met.

1-13. (canceled)

14. A method for fire fighting, comprising:
providing at least one extinguishing fluid container for producing an extinguishing fog via at least one extinguishing fog nozzle, at least one extinguishing gas nozzle, and a joint propellant supply connected to the at least one extinguishing fog nozzle and the at least one extinguishing gas nozzle;
exclusively pressurizing with propellant via the joint propellant supply either the extinguishing fluid container or the extinguishing gas nozzle; and
controlling the exclusive pressurization of the extinguishing fluid container or the extinguishing gas nozzle with fire alarms that are independent from one another.

15. A method according to claim 14, wherein the exclusive pressurization of the extinguishing fluid container or the extinguishing gas nozzle is controlled by means of a valve.

16. A method according to claim 14, wherein the propellant is a gas from the group inert gas, nitrogen, carbon dioxide, argon, halon, or combinations thereof.

17. A fire fighting device, comprising:
at least one extinguishing fluid container connected to at least one extinguishing fog nozzle for producing extinguishing fog;
at least one extinguishing gas nozzle for releasing propellant; and
a propellant supply for feeding the extinguishing fluid container and the extinguishing gas nozzle jointly with propellant;
wherein the propellant supply is connected to the extinguishing fluid container and the extinguishing gas nozzle such that either exclusively the extinguishing fluid container or exclusively the extinguishing gas nozzle are pressurized with propellant; and
wherein at least two fire alarms, independent from one another, trigger exclusive pressurization of the extinguishing fluid container or the extinguishing gas nozzle.

18. A fire fighting device according to claim 17, further comprising a valve arranged between the propellant supply, extinguishing fluid container, and extinguishing gas nozzle for exclusive pressurization of the extinguishing fluid container or the extinguishing gas nozzle.

19. A fire fighting device according to claim 18, wherein the valve either opens the connection between the extinguishing fluid container and the propellant supply, or the connection between the extinguishing gas nozzle and the propellant supply, and closes the respective other connection accordingly.

20. A fire fighting device according to claim 17, wherein the extinguishing fog nozzle and the extinguishing gas nozzle are located in areas separated from one another.

21. A fire fighting device according to claim 17, wherein the fire alarms are located in areas separated from one another.

22. A fire fighting device according to claim 21, wherein a first area is a passenger compartment in a railway vehicle, and a second area is a motor coach in a railway vehicle.

23. A method of fire fighting, comprising the steps of:
providing at least one extinguishing fluid container for producing an extinguishing fog via at least one extinguishing fog nozzle, at least one extinguishing gas nozzle, and a joint propellant supply connected to the at least one extinguishing fog nozzle and the at least one extinguishing gas nozzle;
exclusively pressurizing with propellant via the joint propellant supply either the extinguishing fluid container or the extinguishing gas nozzle;
controlling the exclusive pressurization of the extinguishing fluid container or the extinguishing gas nozzle by means of a valve; and
controlling the valve by means of a first fire alarm and a second fire alarm, the two fire alarms being independent from one another, wherein the first fire alarm causes the valve to cause exclusive pressurization of the extinguishing fluid container, and the second fire alarm causes the valve to cause exclusive pressurization of the extinguishing gas nozzle.

24. A fire fighting device, comprising:
at least one extinguishing fluid container, connected to at least one extinguishing fog nozzle for releasing extinguishing fog;
at least one extinguishing gas nozzle for releasing propellant; and
a propellant supply feeding the extinguishing fluid container and the extinguishing gas nozzle jointly with propellant;
wherein the propellant supply is connected to the extinguishing fluid container and the extinguishing gas nozzle such that either exclusively the extinguishing fluid container or exclusively the extinguishing gas nozzle can be pressurized with propellant; and
wherein a valve is provided for exclusive pressurization of the extinguishing fluid container or the extinguishing gas nozzle; and
wherein a first fire alarm is provided for triggering exclusive pressurization of the extinguishing fluid container and a second fire alarm is provided for triggering exclusive pressurization of the extinguishing gas nozzle, and the two fire alarms are independent from one another.
